(19) United States
(12) Patent Application Publication
(10) Pub. No.: US 2003/0158900 A1
(43) Pub. Date: Aug. 21, 2003

(54) Method of and apparatus for teleconferencing

(76) Inventor: Richard A. Santos, Roseville, CA (US)

Correspondence Address: HEWLETT-PACKARD COMPANY, Intellectual Property Administration, P.O. Box 272400, Fort Collins, CO, 80527-2400, US

(21) Appl. No.: 10/068,394

(22) Filed: Feb. 5, 2002

(51) Int. Cl. H04L 12/16; H04L 12/28; G06F 15/16

(52) U.S. Cl. 709/205; 370/260; 370/401

(57) ABSTRACT

The invention includes a conference call system that includes a conference bridge configured to conference together communications between conference participants into a conference call. A conference monitor may be configured to allow a host to dynamically create a web page to provide an indication of ones of said conference participants who have joined the conference call. A web server may be configured to host the web page for access by one or more of the conference call participants.

### TECHNICAL FIELD

The invention is related to teleconferencing systems and, more particularly, to computer systems to perform teleconferencing management functions.

### BACKGROUND

Various systems and methods allow multiple parties at diverse locations to remotely participate in a meeting using appropriate communications systems. For example, three or more parties at different remote locations may participate in a telephone conference (“teleconference”) call using readily available three-way calling available on many telephone systems. Additional parties may participate using similar systems including, for example, conference bridges or, more specifically in the case of conventional voice circuits, conference bridges allowing six or even more participants to conduct a teleconference call using existing public switch telephone network (PSTN) facilities. Such conference bridges may be scheduled by a teleconference leader or host. According to one arrangement, participants dial into a telephone number assigned to the bridge at the appointed time and are automatically connected to each other, i.e., conferenced together. Alternatively, participants may designate a particular teleconference to join by entering information using the DTMF keypad of their telephone and/or entering a personal identification number (PIN) to join a designated conference. Other bridges may require an operator to greet callers, verify the caller's participation in a particular conference, and transfer the call to the conference bridge and the other teleconference participants. Still other systems require or allow an operator or host to initiate calls to invited participants, connecting each called participant as they confirm their identify to the operator or host.

Typically, large teleconferences are scheduled in advance to allow reservation of any required teleconferencing equipment such as a conference bridge. In addition to scheduling the required resources such as the teleconferencing conference bridge, the person making arrangements for the teleconference (e.g., the teleconference leader or host) must inform all invited participants of how to join the conference. This information may be provided by placing telephone calls in advance of the scheduled teleconference to each of the potential participants, arranging during a prior teleconference for the upcoming teleconference, sending e-mails to invited participants, such that required information such as meeting time, duration, agenda, dial-in telephone number, required PIN's, etc. is disseminated to the potential participants. Some of this information including, for example, the dial-in telephone number, may be obtained from a service entity or vendor providing the teleconference bridge and other teleconferencing facilities.

The teleconference bridge facilities may automate portions of the login procedure as teleconference participants dial in, have their calls answered, and eventually join the teleconference. For example, a caller may be greeted by a prerecorded or automated message asking for a teleconference identification number and/or a PIN to properly route the call to a desired teleconference and verify that the calling party is authorized to participate in the teleconference. The system may further include facilities to announce that a caller is joining a teleconference call by, for example, asking the caller to record their name and location for playback to the participants who have previously joined the teleconference upon the new participant joining the teleconference. Alternatively, a human operator may announce to the other participants the name of each caller as they join the meeting. In either case, the teleconference leader and, in some cases, other participants may be able to retrieve a list of all participating callers by using, for example, a control function recognized by the bridge. For example, a participant may dial “#1” to obtain a teleconference role call/roster which temporarily disconnects that party from the teleconference and plays the recorded name of all people who are currently connected to the conference. Alternatively, the names may be played to the entire teleconference as a role call. This feature allows a participant who has joined the teleconference at a later time to get a full listing of all participants which may be written down for future reference. This list may be manually updated as each participant joins the teleconference or, periodically, the role call feature may be used to replay the names of each participant.

Other systems and products provide other forms of conferencing. For example, Microsoft's Netmeeting® supports video and audio conferencing over an internet connection. In addition to allowing multiple parties to verbally interact, the system provides the exchange of video information, white board functions, text messaging, program sharing, file transfer, and other functions. Each participant runs the Netmeeting program on a suitable personal computer or other platform to provide for their participation in the conference-type meeting. However, the internet conferencing systems are distinct from typical PSTN type teleconferencing systems. The internet systems are directed more toward real-time, multimedia, multiparty communications over computer networks and do not support many features of conventional telephony conference systems.

### SUMMARY OF THE INVENTION

The present invention includes a conference call system including a conference bridge configured to conference together communications between conference participants into a conference call and a conference monitor configured to allow a host to dynamically create a web page to provide an indication of ones of the conference participants who have joined the conference call. Additionally, the present invention includes a web server configured to host the web page for access by one or more of the conference participants.

### BRIEF DESCRIPTION OF THE DRAWINGS

FIG. 1 is a block diagram of an embodiment of a conference call system according to the invention;

FIG. 2 is a block diagram of an embodiment of the invention including a host system and related functionality connected to voice and data networks for hosting a teleconference and, simultaneously, providing web-based information about the teleconference;

FIG. 3 is a front view of an embodiment of the invention including a computer monitor displaying a web page including status information; and

FIG. 4 is an embodiment of a method according to the invention.

### DETAILED DESCRIPTION

Referring to FIG. 1 of the drawings, a teleconference call system 101 supports multiple participants at locations 124, 125, 126, and 127. Each of these locations is provided with voice and/or data connectivity using various communication systems such as the public switch telephone network (PSTN), as shown in the form of voice network 108, and a data network such as Internet 119. Access to Internet 119 may be provided by the PSTN infrastructure including telephone switches 107, 109, 112, and 114 or via other interfaces (not shown) such as cellular, BLUETOOTH™ wireless, direct LAN connectivity to the Internet via an appropriate router and ISP (internet service provider), satellite, etc. Although FIG. 1 illustrates support for four teleconference participants, including a teleconference coordinator at location 124, any number of, but not limited to, teleconference participants may be included, the invention being particularly applicable to conferences having a large number of participants.

For the purposes of the present illustration, it is assumed that a teleconference leader or host is also a participant in the teleconference call, although this is not required. Thus, the teleconference leader may be located at site 124, including a computer platform 102, local conference bridge 105, and conventional telephone instrument in the form of telephone 106. Conference bridge 105 may be in the form of a voice bridge in those embodiments limited to voice communications, but may include video, data and other forms of conferencing bridges, switches, routers and similar equipment and facilities as appropriate to the medium. Computer platform 102 may be a personal computer or similar platform including, for example, web server 103 and web browser 104. Web server 103 may include a dedicated connection to conference bridge 105 for the exchange of information therebetween. For example, port assignments for each of the participants supported by conference bridge 105 may be communicated to web server 103 so as to update the status of each participant and to identify which of the participants is presently speaking. Web browser 104 may be used to provide other control functionality and to support e-mail messaging with and among other participants. Of course, e-mail messaging may also be provided by an appropriate dedicated e-mail client such as Microsoft Outlook®. For example, web browser 104 may be used to control conference bridge 105 during the teleconference so as to establish port assignments, PIN's, etc.

Telephone 106 may be a conventional touchtone telephone supporting standard DTMF signaling. Alternatively, any other form of conference capable communication media may be substituted or may augment the teleconference. For example, telephone 106 may further comprise a video conferencing system supporting partial or full motion video in addition to audio. Further, telephone 106 may be supported by various local telephone switching equipment such as a private branch exchange (PBX) system. For purposes of the present example, communications directly in support of the teleconference call is supported by the PSTN such that appropriate audio and/or video customer provided equipment (CPE) interfaces to the PSTN at switch 107, such as a telephone central office.

As described, the communications infrastructure connecting the various participants may include the PSTN and associated data network such as Internet 119. The PSTN includes various voice and data switches 107, 109, 112, and 114 interfacing customer telephony equipment (CTE) to PSTN voice network 108 and, as appropriate, to Internet 119 via appropriately provisioned routers (not shown). Switches 107, 109, 112, and 114 are further interfaced to a PSTN data network used for transmission and coordination of PSTN control and operation messaging using, for example, a common channel signaling (CCS) network, such as SS7 signaling network 120. Switches 107, 109, 112, and 114 may be in the form of SSPs (service switching points) which provide both voice switching and access to signal transfer points (STPs) 121 and 122 which, in turn, connect SS7 signaling network 120. Service control point (SCP) 123 further supports database management functionality for SS7 signaling network 120 and provides an interface to the CCS network for intelligent peripherals (IPs) such as may be had according to one implementation of conference bridge 105. Thus, an 1129+ protocol interface may be used to connect conference bridge 105 to SCP 123 or, directly to STP 121 or 122 to provide networking information including, for example, automatic number identification (ANI) information about and associated with participants as their respective calls are routed to conference bridge 105. Alternatively, even without a data interface to SS7 signaling network 120, conference bridge 105 may be provided with ANI information directly from switch 107 via an appropriate in-band trunk protocol. Still, according to another embodiment, individual line-sided connections may be provided between switch 107 and conference bridge 105, with caller identification being provided by in-band FSK signaling.

Also connected to the voice and data communications infrastructure supported by voice network 108 and Internet 119 are users at locations 125, 126, and 127, each location supporting one or more teleconference participants. Locations 125 and 126 are shown as having substantially equivalent equipment including conventional telephones 111 and 116 for connecting via respective switches 109 and 114 to voice network 108 and, ultimately, to conference bridge 105. In addition to voice connectivity, participants at locations 125 and 126 have appropriate web browsers 110 and 115 configured to access web pages resident on web server 103. Although depicted as running on personal computers, web browsers 110 and 115 may be supported by any number of platforms including, but not limited to, personal computers, mainframe computers, PDAs, Internet set top box devices, etc. Of course, web browser 104 at location 124 may also access web server 103. Preferably, web server 103 maintains a web page including some indication of participants who have already joined and/or are invited but have not yet joined the teleconference call. This indication may include the participants name, location, other identifying information, notes, etc. A participant at location 127 also includes an appropriate computer platform to support web browser 117. However, in the case of location 127, voice connectivity with conference bridge 105 (so as to provide teleconferencing capabilities) is provided by appropriate voice over IP(VoIP) telephone device and associated software. The VoIP runs on an associated computer platform and replaces a conventional telephone to provide voice connectivity. As shown, web browser 117 and VoIP telephone device 118 are connected to switch 114 and Internet 119. In this case, Internet 119 is further connected to switch 107 where an appropriate switch is used to interface the VoIP messaging from VoIP device 118 with conference bridge 105.

As an alternative to a dedicated conference bridge 105 at location 124, other teleconferencing, video conferencing, or other forms of conferencing bridges may be provided and/or located at other parts of the network. For example, conference bridge 113 may be provided by a service provider and interfaced to an appropriate voice switch 112. In this case, conference bridge 113 may include further data interfaces with voice network 108 (e.g., a 1129+ interface) to provide control of the conference bridge and/or trunk signaling capabilities. The 1129+ interface may also be used to provide control of conference bridge 113 via SCP 123 over SS7 signaling network 120 and STP 122.

Primary functionality provided according to the invention is supported by web server 103 which may include appropriate software for web page composition. Typically, web server 103 would include software required to compose a web page and, importantly, simplified means for updating data supplied on the web page so that information about teleconference participants may be easily updated. The updating function may be manually accomplished by a user using, for example, web browser 104 or other interface software. In addition, updating of the web page may occur automatically in response to data provided by conference bridge 105 to web server 103 including, for example, ANI of incoming calls. In this case, the user may have had previously associated caller information including telephone numbers with caller names so that web server 103 is able to identify participants as their perspective call are answered by conference bridge 105. Alternatively, other means of identifying callers may be implemented by either conference bridge 105 and/or appropriate software on web server 103. Such means of identification may include, for example, identification of callers based on voice recognition of their spoken name, entry of participant PIN, speaker dependent voice recognition, or a manual entry by the participant using DTMF input or by the teleconference leader inputting the data using appropriate software residing on web browser 104 or another suitable platform. Then again, each participant may use their web browser 110, 115 or 127 to independently login into the teleconference via web server 103, each participant updating the web page upon logging into the system.

In addition to indicating which participants have joined the teleconference call, web server 103 in combination with conference bridge 105 (or conference bridge 113, as appropriate) may provide other functionality. This additional functionality may include the display of a photo of or other material associated with each participant. In addition, conference bridge 105 may recognize audio on a particular port associated with a respective one of the teleconference participants or may incorporate voice recognition software to identify when a participant is speaking and appropriately highlight identification data associated with that teleconference participant on the web server 103. For example, a picture of the participant now speaking may be highlighted by web server 103 in response to conference bridge 105 receiving audio on a port that has been dialed into by the participant as identified by, for example, ANI associated with that participant. In response to audio on the associated port, web server 103 highlights the picture of the participant and, optionally, pushes the updated web page to participants who have logged in and have supplied their IP addresses, such as browsers 104, 110, 115, and 117. Alternatively, a live picture of the participant now speaking as available via a webcam may be displayed, either as part of the current display or in a separate enlarged window area.

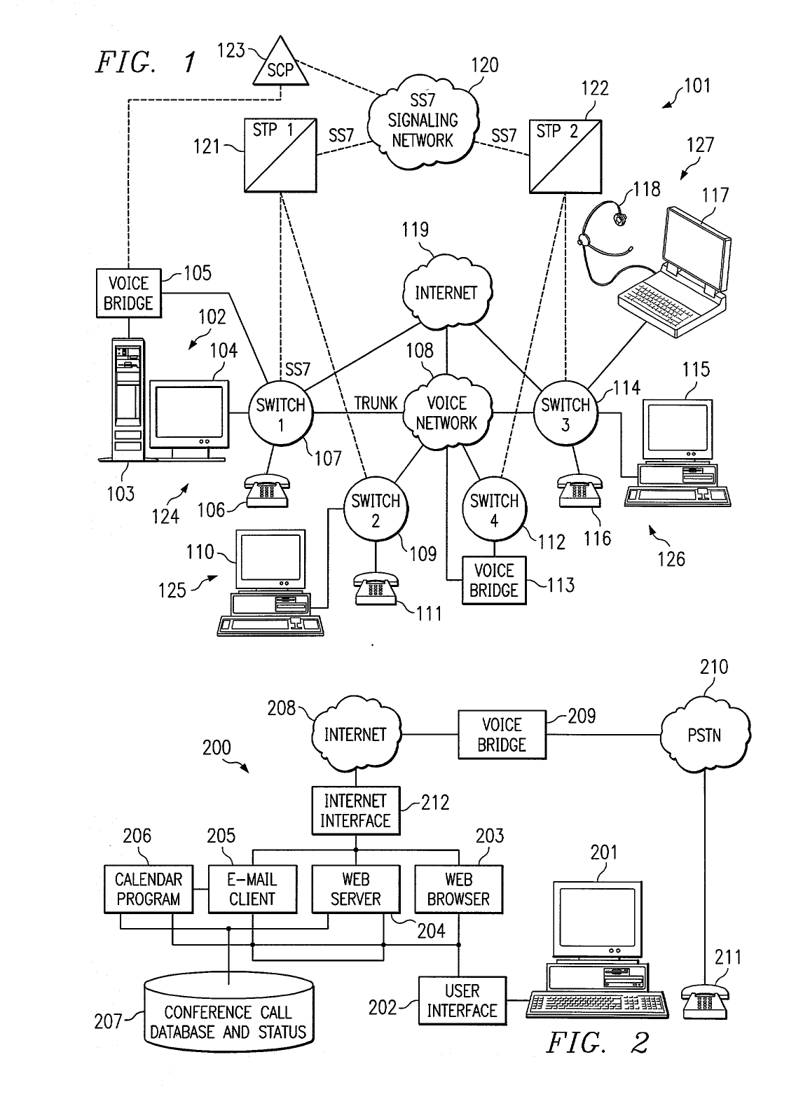

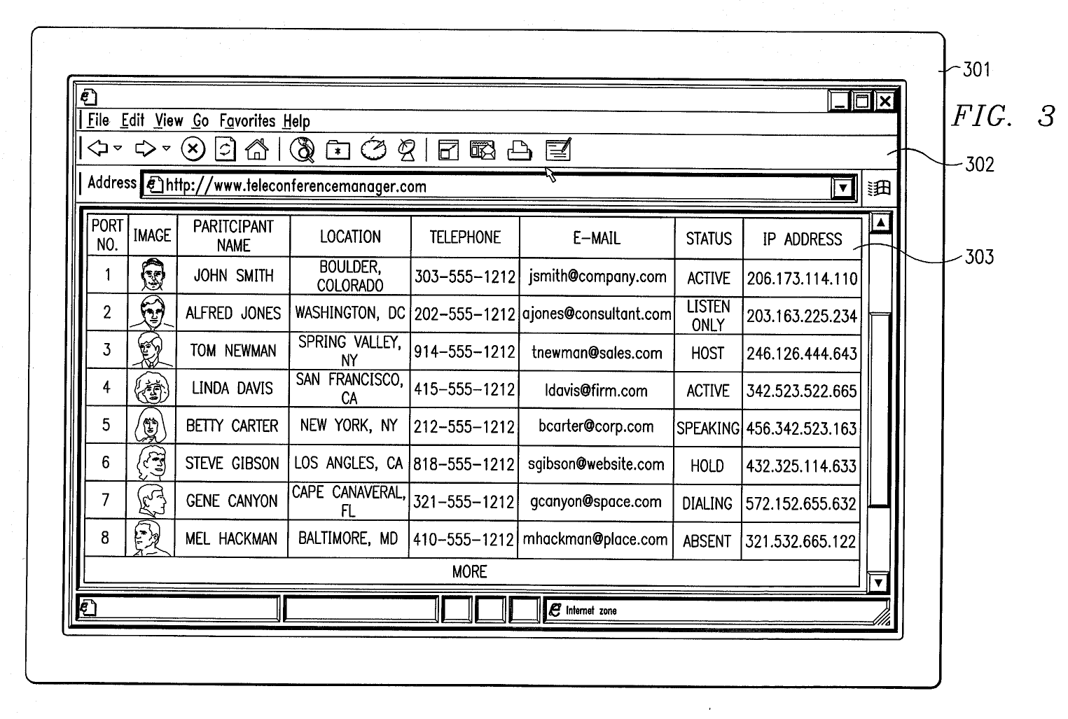

FIG. 2 is a block diagram of a platform 200 supporting functionality provided by web server 103 and web browser 104 in addition to other functionality useful to a teleconference leader. The platform includes, for example, a personal computer 201 with appropriate user interface 202 to applications running on the platform. The user interface may include a typical graphical user interface (GUI), keyboard, pointing device, voice recognition, or other forms of interface. Platform 200 may further provide web browser 203 functionality. Conversely, web server 204 may include an appropriate web page storage, web page creation, and maintenance, updating facilities and other functionality required to generate and supply web pages to remote clients. Web server 204 may further include voice recognition capabilities so as to dynamically update participant information and track the identities of participants based on speech recognition facilities.

The platform may provide and support e-mail client 205 supporting further functionalities. For example, e-mail client 205 may be used to coordinate the teleconference with other participants, provide for the distribution of PINs and calling information, and provide another method of information exchange with web server 204 by remote participants. For example, remote participants may elect to log into the teleconference by sending an e-mail to the teleconference leader and/or web server 204 so as to update the appropriate web page. This information including the database of call teleconference participants and the status of the participant may be stored in the database 207.

In addition to dynamic updating of the web page supported by web server 204, the platform may support an appropriate calendaring program 206 for automatically setup a conference including, for example, scheduling teleconference facilities, informing invited participants of an upcoming scheduled teleconference, and, at the appropriate time, initiating the teleconferencing facilities, e.g., activating the conferencing bridge. Calendaring program 206 may interface with e-mail client 205 to provide e-mail messaging to teleconference invitees including information required to access the teleconference and to send reminders to the participants. In addition, invitees identified by calendaring program 206 may be stored in database 207 and, at the time of the conference, absent invitees may be reminded via e-mail client 205 that the teleconference has started.

In addition to providing information about the teleconference call, participants, and other related information, web server 204 may further provide a means for remote client software (e.g., browsers) used by participants to update the web page using appropriate HTML and CGI.

Interface to Internet 208 is provided by internet interface 212. As one skilled in the art would recognize, other data connectivity may be provided, including, for example, a local area network (LAN) so as to interface with conference bridge 209 and with other participants connected to Internet 208 to support web page creation, access, e-mail functionality, etc. Further, although the web server 204 may implement a “pull” protocol wherein remote participants receive static web page information, a push protocol may be implemented so as to provide dynamically updated teleconference information via the web page as participants log in and out of the call and as various participants converse.

Conference bridge 209 connects with both Internet 208 and PSTN 210. In the case of the former connectivity, conference bridge 209 may provide information about callers including, for example, port assignment, ANI, port activity indicators, speaker recognition information, etc., via Internet 208 to web server 204 so as to update the teleconference web page. Conference bridge 209 further interconnects with PSTN 210 to conference together voice lines and calls from perspective participants using, for example, telephone 211.

Operationally, a teleconference leader or host may schedule use of a particular conference bridge by appropriate means such as by calling a teleconference center or sending an e-mail requesting use of a conference bridge and identifying how many participants are expected. The teleconference center would assign a conference bridge, call-in telephone number, PINs and other information need to reserve and access the conference bridge. This information is provided to the host and/or directly to participants via, for example, e-mail and may also be supplied to the teleconference leader for inclusion in a web page. The teleconference leader may further receive identifying information from participants including, for example, photographs or other images, data about the participant, voice samples used to identify the participant, etc. This information is used by the web server and may be stored, for example, in database 207. Using appropriate software, the teleconference leader manually inputs participant information into web server 204 so as to update the appropriate fields of a predefined teleconference web page. Alternatively, this information may be automatically inserted into a pre-existing web page designed to reflect teleconference participant identities and status.

At the time of the teleconference, participants may use conventional PSTN facilities to dial into the conference bridge. The conference bridge receives the telephone call and associated ANI via, for example, appropriate trunking facilities. The ANI together with port assignment information is transmitted to the web server so as to update the web page indicating that a particular participant has joined the conference. In response, the web page is updated to indicate the participant's enrollment. After some period of time, for example, five minutes, invitees who have failed to log into the teleconference call may be notified by e-mail that the teleconference is in progress. Alternatively, dial-out facilities of the conference bridge may be activated to dial out to and invite non-participating or “absent” invitees to join the teleconference call. In this latter case, the conference bridge includes a prerecorded or automated message soliciting an invitee's participation. Once an outgoing call soliciting invitee participation is completed and the invited participant identifies him- or herself appropriately to the system, the participant would then be allowed to join the teleconference just as if they had initiated the call by dialing into the bridge.

FIG. 3 is an example of a web page indicating participant status. Monitor 301 or its equivalent is used to display information about the teleconference call using web browser display 302 to access web server 103 (FIG. 1). Information about the participants may be displayed in the form of table 303 including, for example, for each of the invitees and/or participants, an associated port assignment, a picture of the participant (e.g., a static image or, if available, a video image), the participant's name, location, telephone number and e-mail address. The status of the participant may also be indicated including, for example, whether the participant has logged into the teleconference as might be indicated by “active” status, whether the participant had joined to only monitor the teleconference (e.g., “listen only”), whether the participant is hosting or otherwise in control of the teleconference, is on hold, absent, or is being dialed or called by the system. Status indicator may also be provided to indicate that a particular participant is speaking as may be detected by activity on the corresponding bridge port, voice recognition, or manually input by, for example, the teleconference host. Also provided by way of illustration are the IP addresses of each of the participants thereby providing for “pushing” of updated data to the respective web browsers. Other information may also be displayed, including, for example, time of day, time remaining in conference, agenda items to be covered by particular participants, e-mail windows associated with respective participants, etc. Further, participants' specific web sites may be established to individualize the information sent to and received from particular participants.

While FIG. 3 lists the participants and invitees in port order, other orders and functionalities may be provided. For example, the most recent participants speaking may be ordered to appear on an active page such that relatively inactive conferencees would be displayed at the bottom of the list or, if necessary, on other pages. Further, as previously described, highlighting of participant information and/or participant images may be used to identify participant status including, for example, whether a particular participant is speaking. Still further, the web page may incorporate facilities to display a still or live picture of a participant who is currently speaking in, for example, a larger window. The image of the participant currently speaking may be supplied by a “webcam” connected to the speaker's computer or may be otherwise supplied such as from an image file on the speaker's computer.

Note that the invention has been described in terms of teleconference, however, the invention will operate for any type of conference.

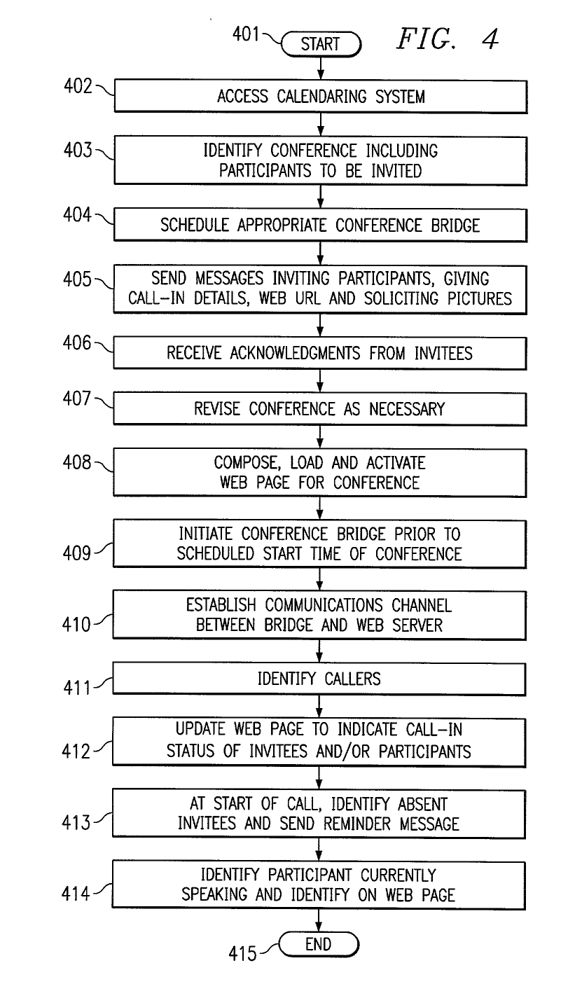

A method according to an embodiment of the invention is depicted by the flowchart of FIG. 4. Starting at step 401, a resident calendaring system is accessed at step 402, either automatically (e.g., periodically), or as manually initiated, so as to provide scheduling information about an upcoming conference. Any such planned conference is identified at step 403 together with the identification of participants to be invited to be part of the conference, i.e., “invitees.” Scheduling of an appropriate conference bridge is performed at step 404. This may include, for example, interfacing with conference bridge scheduling software, sending an e-mail to a conference facility coordinator, and/or performing other tasks required to assure availability of a suitable conferencing facility to support the planned conference call.

Upon confirmation and scheduling of conference call facilities, appropriate messages are sent to the invitees at step 405, including details of the conference call. Such details may include, for example, call-in telephone numbers, any personal identification numbers (PINs) required and details for accessing data related to the conference call such as the web address of a web site and/or web page to be associated with the conference call. This web page provides real-time information about invitees participating in the conference call and identification of participants presently speaking. In support of such a page, the message sent to the invitees may include a request for information about the invitee, such as nickname, location, technical specialty, title, etc. In addition, each invitee may be solicited to provide a picture of himself or herself for inclusion in the conference web page and used to identify participation by the invitee during the conference call. Of course, the web page may include other information, such as planned agenda, meeting notes, related documents, etc.

At step 406, acknowledgements are received from invitees indicating their planned participation or absence from the scheduled conference. If, based on responses from the invitees, it appears necessary to revise the conference schedule, this is performed at step 407.

Based on the previously accumulated information and any manually entered information, an appropriate web page for the scheduled conference is composed at step 408. Composition of the web page may include, for example, incorporation of invitee information, creation of links to related pages, etc. The web page is further loaded onto an appropriate web server and the page is made available for access by the invitees. Note that access may require a conference participant to log-in to the web server to gain access to the web page. Further, standard security measures may be incorporated depending on the requirements of the conference call, including, for example, use of encryption and SSL to secure and protect communications with the web server.

At a predetermined time in advance of the scheduled conference, the appropriate bridging facilities are initiated at step 409. This may include, for example, logging-in to the bridge by a conference leader using an appropriate PIN, transmission of a message to a conference facility authorizing use of the bridge and providing appropriate accounting or charge-back information, etc. At step 410 a communication channel is established between the bridge facilities and the web server so that real-time display of bridge and conference participant status and information may be coordinated between the two platforms.

As invitees call into the bridge, they are identified at step 411 and logged in. Identification of callers may be provided by automatic number identification (ANI), voice identification of the caller, manually initiated log-in using, for example, DTMF signaling, entry of a PIN, or separate log-in procedure via the web page to indicate that a particular invitee has joined the conference and is participating. Participant and other data is then displayed to other users at step 412 over the web page associated with the conference.

Step 413 provides a reminder to conference invitees who have failed to call-in and/or log-in to the conference by sending an appropriate reminder message. The reminder message may be in a form of, for example, an e-mail message or an automated outgoing voice call to the absent invitee. In the case of the later, the invitee, if reached by telephone, may be invited to join the conference by entering an appropriate DTMF signal such as their pre-assigned PIN code. If the invitee elects to join the conference, the call may be transferred to the bridge or otherwise connected to the other participants.

Step 414 performs ongoing identification of participants based on voice recognition so as to display an indication of the person currently speaking on the conference web page. Such indication may be provided by highlighting the name or picture of the speaker, displaying their picture or identity to a special area of the display or if available, providing a real-time web cam picture of the speaker for display on the web page. Processing ends at step 415 upon termination of the conference.

What is claimed is:

1. A conference call system comprising:
a conference bridge configured to conference together communications between conference participants into a conference call; and
a conference monitor configured to allow a host to dynamically create a web page to provide an indication of ones of said conference participants who have joined said conference call.

2. The conference call system according to claim 1 further comprising a web server configured to host said web page for access by one or more of said conference participants.

3. The conference call system according to claim 1 wherein said conference bridge is further configured to identify said participants who have joined said conference call to said conference monitor whereby said indication of ones of said participants who have joined said conference call is dynamically updated.

4. The conference call system according to claim 3 wherein said conference bridge is responsive to Automatic Number Identification information to identify participants who have joined said conference call.

5. The conference call system according to claim 1 wherein said conference call monitor is configured to monitor said conference call and identify participants who have joined said conference call.

6. The conference call system according to claim 5 wherein said conference call monitor includes a speech recognition processor configured to detect spoken identification information of said conference participants.

7. The conference call system according to claim 1 further comprising a conference call scheduler configured to reserve said conference bridge, advise said conference participants of details for accessing said conference bridge, and identify to said conference monitor identities of said conference participants.

8. The conference call system according to claim 1 wherein said conference bridge includes a plurality of ports configured to communicate with respective ones of said conference participants.

9. The conference call system according to claim 1 further comprising an electronic messaging system configured to generate messages to said conference participants including a uniform resource locator address of said web page.

10. The conference call system according to claim 1 further including an interface to a common channel signaling system configured to receive identifying information of said participants who have joined said conference call.

11. The conference call system according to claim 1 wherein said conference monitor includes an operator interface configured to receive designations of said participants who have joined said conference call.

12. The conference call system according to claim 1 further comprising a database of images corresponding to each of said conference participants, said conference monitor configured associate said images with said conference participants for incorporation by said web server into said web page.

13. The conference call system according to claim 1 wherein said conference bridge is further configured to perform voice recognition based identification of a speaker.

14. The conference call system according to claim 1 further comprising a calendaring program configured to setup a conference call.

15. The conference call system according to claim 15 wherein said calendaring program is further configured to initiate said conference bridge.

16. The conference call system according to claim 1 further comprising a messaging program in communication with said conference monitor and configured to a reminder message to an absent invitee.

17. A method of conducting a conference call comprising the steps of:
conferencing together communications between conference participants to form a conference call;
creating a web page to provide said indication of ones of said participants who have joined said conference call; and
updating said web page as additional ones of said participants join said conference call.

18. The method of conducting a conference call according to claim 17 further comprising a step of hosting said web page for access by one or more of said participants.

19. The method of conducting a conference call according to claim 17 further comprising a step of decoding Automatic Number Identification information and, in response, identifying said participants who have joined said conference call.

20. The method of conducting a conference call according to claim 17 further comprising a step of monitoring said conference call and, in response, identifying said participants who have joined said conference call.

21. The method of conducting a conference call according to claim 20 wherein said step of monitoring includes a step of recognizing speech so as to detect spoken identification information of said conference participants.

22. The method of conducting a conference call according to claim 17 further comprising the steps of reserving said conference bridge, advising said conference participants of details for accessing said conference bridge, and identifying identities of said conference participants.

23. The method of conducting a conference call according to claim 17 wherein said conference bridge includes a plurality of ports configured to communicate with respective ones of said conference participants.

24. The method of conducting a conference call according to claim 17 further comprising the steps of an electronic messaging system configured to generate messages to said conference participants, said messages including a uniform resource locator address of said web page.

25. The method of conducting a conference call according to claim 17 further including an interface to a common channel signaling system configured to receive identifying information of said participants who have joined said conference call.

26. The method of conducting a conference call according to claim 17 wherein said conference monitor includes an operator interface configured to receive designations of said participants who have joined said conference call.

27. The method of conducting a conference call according to claim 17 further comprising a step of performing voice recognition based identification of one of said conference participants.

28. The method of conducting a conference call according to claim 17 further comprising the steps of calendaring said conference call and, in response, automatically setting up said conference call.

29. The method of conducting a conference call according to claim 29 wherein said step of setting up said conference call includes initiating a conference bridge.

30. The method of conducting a conference call according to claim 17 further comprising the steps of identifying an absent invitee from said conference call and, in response, sending a reminder message to said absent invitee.
